(19) United States
(12) Patent Application Publication
(10) Pub. No.: US 2026/0175407 A1
(43) Pub. Date: Jun. 25, 2026

(54) ROBOT SYSTEM AND COLOR CONTROL METHOD

(71) Applicants: SHANGHAI FLEXIV ROBOTICS TECHNOLOGY CO., LTD., Shanghai (CN); FLEXIV LTD., Grand Cayman (KY)

(72) Inventors: Brian SOE, Santa Clara, CA (US); Howard HUANG, Santa Clara, CA (US)

(21) Appl. No.: 19/124,671

(22) PCT Filed: Oct. 27, 2022
(86) PCT No.: PCT/CN2022/128005

§ 371 Date: Apr. 25, 2025

(51) Int. Cl. B25J 9/00; B25J 9/16

(52) U.S. Cl. CPC B25J 9/0084; B25J 9/0003; B25J 9/1602

(57) ABSTRACT

A robot system and a color control method thereof are disclosed. The robot system includes at least two robots and a server that are connected to a communication network. The server is configured to run an IDE and display a GUI of the IDE to provide a VPL tool use the VPL tool to select first and second initial VPL blocks respectively corresponding to the first and second robots; acquire first color information indicating a first color and second color information indicating a second color respectively from the first and second initial VPL blocks; and send the first and second color information to the first and second robots, respectively. The first or second robot controls, in response to the received first or second color information, the plurality of light-emitting devices thereof to display the first or second color.

### CROSS-REFERENCES TO RELATED APPLICATIONS

This application is the national phase under 35 U.S.C. § 371 of PCT international application No. PCT/CN2022/128005, which has an international filing date of Oct. 27, 2022, the content of which is hereby incorporated in its entirety by reference for all purposes.

### FIELD

The present disclosure relates generally to articulated robots, and in particular, to a robot system including a plurality of articulated robots and a color control method thereof.

### BACKGROUND

An articulated robot is a robot with rotary joints, also known as an articulated robot arm or a multi-joint robot. The articulated robot can range from a simple two-joint structure to a system with more than ten interactive joints. The articulated robot is one of the most common forms of industrial robots in today's industrial field, which is suitable for mechanical automation in lots of industrial fields.

As structural complexity of the articulated robot and difficulty of a to-be-performed task increase, in order to facilitate task planning for the articulated robot, an integrated development environment (IDE) has been used to program the articulated robot. The IDE is application software that assists a program developer to develop software, which can assist in writing source code text and compile and package the source code text into usable programs inside a development tool. The IDE generally includes a programming language editor, an automated build tool, and a debugger. The IDE can combine a common developer tool into a single graphical user interface (GUI), so the developer can perform operations without switching application programs.

The IDE for supporting visual programming can allow the developer to create flow charts and structure charts by directly moving programmed building blocks or code nodes, and then compile or interpret the created flow charts and structure charts to create new application programs. Such flow charts and structure charts are generally based on a unified modeling language. The GUI of such an IDE provides a Visual Programming Language (VPL) environment. A VPL is also referred to as a graphical programming language, which is a programming language that allows a user to create programs by operating program elements graphically rather than by text specification. The VPL allows programming using visual expressions and spatial arrangements of text and graphic symbols. For example, many VPLs are based on the concept of “blocks and arrows,” in which blocks or other screen objects are treated as entities that are connected by arrows, straight segments, or arcs representing relationships.

### SUMMARY

One aspect of the present disclosure relates to a robot system. The robot system includes at least two articulated robots. Each of the articulated robots includes a robot controller, a plurality of rotary joints, and a plurality of light-emitting devices. Each of the light-emitting devices is arranged at the corresponding rotary joint of the plurality of rotary joints. The robot system further includes a server. The server includes a controller, a storage unit, and a display unit. The storage unit stores a plurality of instructions executable by the controller and stores a VPL library including a plurality of VPL blocks.

The at least two articulated robots and the server are connected to a communication network. The at least two articulated robots include a first articulated robot and a second articulated robot.

The server is configured to use the controller to execute the instructions from the storage unit to run an IDE, and use the display unit to display a GUI of the IDE. The GUI is configured to provide a VPL tool.

The server is configured to use the VPL tool to select a first initial VPL block and a second initial VPL block from the VPL library. The first initial VPL block corresponds to the first articulated robot, while the second initial VPL block corresponds to the second articulated robot. The server establishes a first connection based on the IDE with the first articulated robot over the communication network after selecting the first initial VPL block, and the server establishes a second connection based on the IDE with the second articulated robot over the communication network after selecting the second initial VPL block.

The server is configured to acquire first color information indicating a first color from the first initial VPL block, and acquire second color information indicating a second color from the second initial VPL block. The second color is different from the first color. The server is configured to send the acquired first color information and the acquired second color information to the first articulated robot and the second articulated robot respectively via the first connection and the second connection.

The robot controller of the first articulated robot is configured to generate a first color instruction in response to the received first color information to control the plurality of light-emitting devices of the first articulated robot to display the first color. The robot controller of the second articulated robot is configured to generate a second color instruction in response to the received second color information to control the plurality of light-emitting devices of the second articulated robot to display the second color.

In the robot system according to the above aspect, each of the at least two articulated robots has a unique identifier, the server is configured to use the VPL tool to create the first initial VPL block in association with the first color information based on the unique identifier of the first articulated robot and create the second initial VPL block in association with the second color information based on the unique identifier of the second articulated robot, and the server is further configured to add the created first initial VPL block and the created second initial VPL block to the VPL library stored in the storage unit.

Particularly, the unique identifier of each of the at least two articulated robots is selected from an Internet protocol address of the articulated robot or a serial number of the articulated robot.

In the robot system according to the above aspect, the server is configured to use the VPL tool to edit the first initial VPL block or the second initial VPL block to modify the first color information or the second color information included in the first initial VPL block or the second initial VPL block, the modified first color information or second color information indicating a color different from the first color or the second color.

In the robot system according to the above aspect, the robot controller of each articulated robot is configured to control the plurality of light-emitting devices of the articulated robot to display a color indicated by color information previously received by the articulated robot when the articulated robot does not establish a connection based on the IDE with the server.

In the robot system according to the above aspect, the server is configured to: use the VPL tool to select a plurality of first task VPL blocks and a plurality of second task VPL blocks from the VPL library, the plurality of first task VPL blocks corresponding to the first articulated robot, the plurality of second task VPL blocks corresponding to the second articulated robot; and display each of the first initial VPL block and the plurality of first task VPL blocks in association with the first color, and display each of the second initial VPL block and the plurality of second task VPL blocks in association with the second color. The first initial VPL block and the plurality of first task VPL blocks constitute a sequence of tasks to be performed by the first articulated robot, and the second initial VPL block and the plurality of second task VPL blocks constitute a sequence of tasks to be performed by the second articulated robot.

Particularly, at least part of each of the first initial VPL block and the plurality of first task VPL blocks presents the first color, and at least part of each of the second initial VPL block and the plurality of second task VPL blocks presents the second color.

More particularly, each of the first initial VPL block and the plurality of first task VPL blocks is outlined in the first color, and each of the second initial VPL block and the plurality of second task VPL blocks are outlined in the second color.

Alternatively, the first color is marked in text form in each of the first initial VPL block and the plurality of first task VPL blocks, and the second color is marked in text form in each of the second initial VPL block and the plurality of second task VPL blocks.

Another aspect of the present disclosure relates to a color control method for a robot system. The robot system includes a server and at least two articulated robots, each of the articulated robots having a robot controller, a plurality of rotary joints, and a plurality of light-emitting devices, each of the light-emitting devices being arranged at the corresponding rotary joint of the plurality of rotary joints, the at least two articulated robots and the server being connected to a communication network, the at least two articulated robots including a first articulated robot and a second articulated robot. The server includes a storage unit, the storage unit storing a VPL library including a plurality of VPL blocks.

The color control method includes: operating, through the server, an IDE, and displaying a GUI of the IDE, the GUI being configured to provide a VPL tool; using, through the server, the VPL tool to select a first initial VPL block and a second initial VPL block from the VPL library, the first initial VPL block corresponding to the first articulated robot, the second initial VPL block corresponding to the second articulated robot; in response to the selection of the first initial VPL block, the server establishing a first connection based on the IDE with the first articulated robot over the communication network, and in response to the selection of the second initial VPL block, the server establishing a second connection based on the IDE with the second articulated robot over the communication network; acquiring, through the server, first color information indicating a first color from the first initial VPL block, and acquiring second color information indicating a second color from the second initial VPL block, wherein the second color is different from the first color; sending, through the server, the acquired first color information and the acquired second color information to the first articulated robot and the second articulated robot respectively via the first connection and the second connection; generating a first color instruction through the first articulated robot in response to the received first color information to control the plurality of light-emitting devices of the first articulated robot to display the first color; and generating a second color instruction through the second articulated robot in response to the received second color information to control the plurality of light-emitting devices of the second articulated robot to display the second color.

In the color control method according to the above aspect, each of the at least two articulated robots has a unique identifier. The color control method further includes: using, through the server, the VPL tool to create the first initial VPL block in association with the first color information based on the unique identifier of the first articulated robot and create the second initial VPL block in association with the second color information based on the unique identifier of the second articulated robot, and adding the created first initial VPL block and the created second initial VPL block to the VPL library stored in the storage unit.

Particularly, the unique identifier of each of the at least two articulated robots is selected from an Internet protocol address of the articulated robot or a serial number of the articulated robot.

In the color control method according to the above aspect, the color control method further includes: using, through the server, the VPL tool to edit the first initial VPL block or the second initial VPL block to modify the first color information or the second color information included in the first initial VPL block or the second initial VPL block, the modified first color information or second color information indicating a color different from the first color or the second color.

In the color control method according to the above aspect, the color control method further includes: when any of the at least two articulated robots does not establish a connection based on the IDE with the server, controlling, through the articulated robot, the plurality of light-emitting devices of the articulated robot to display a color indicated by color information previously received by the articulated robot.

In the color control method according to the above aspect, the color control method further includes: using, through the server, the VPL tool to select a plurality of first task VPL blocks and a plurality of second task VPL blocks from the VPL library, the plurality of first task VPL blocks corresponding to the first articulated robot, the plurality of second task VPL blocks corresponding to the second articulated robot; and displaying each of the first initial VPL block and the plurality of first task VPL blocks in association with the first color, and displaying each of the second initial VPL block and the plurality of second task VPL blocks in association with the second color. The first initial VPL block and the plurality of first task VPL blocks constitute a sequence of tasks to be performed by the first articulated robot, and the second initial VPL block and the plurality of second task VPL blocks constitute a sequence of tasks to be performed by the second articulated robot.

Particularly, at least part of each of the first initial VPL block and the plurality of first task VPL blocks presents the first color, and at least part of each of the second initial VPL block in and the plurality of second task VPL blocks presents the second color.

More particularly, each of the first initial VPL block and the plurality of first task VPL blocks is outlined in the first color, and each of the second initial VPL block and the plurality of second task VPL blocks are outlined in the second color.

Alternatively, the first color is marked in text form in each of the first initial VPL block and the plurality of first task VPL blocks, and the second color is marked in text form in each of the second initial VPL block and the plurality of second task VPL blocks.

### BRIEF DESCRIPTION OF THE DRAWINGS

In order to clearly explain the technical solutions in the embodiments of the present disclosure, the drawings used in the description of the embodiments will be briefly described below. The drawings in the following description are merely exemplary embodiments of the present disclosure. For those of ordinary skill in the art, other embodiments may also be derived based on these drawings without any creative efforts.

FIG. 1 illustrates a structural diagram of an articulated robot applied to an embodiment of the present disclosure.

FIG. 2 illustrates an isometric view of part of the articulated robot applied to an embodiment of the present disclosure.

FIG. 3 illustrates a block diagram of a control system for the articulated robot applied to an embodiment of the present disclosure.

FIG. 4 illustrates a block diagram of a server applied to an embodiment of the present disclosure.

FIG. 5 illustrates a schematic diagram of a robot system according to an embodiment of the present disclosure.

FIG. 6 illustrates a schematic diagram of creating a sequence of tasks of a robot by using a VPL tool according to an embodiment of the present disclosure.

FIG. 7 illustrates the sequence of tasks shown in FIG. 6 which has VPL blocks outlined in corresponding colors.

FIG. 8 illustrates a flowchart of a color control method for use in the robot system shown in FIG. 5.

### DETAILED DESCRIPTION

The disclosure will now be described in detail with reference to the accompanying drawings and examples. The described embodiments are merely exemplary and represent a subset of the embodiments of the present disclosure. Those of ordinary skill in the art may recognize additional embodiments based on the embodiments of the present disclosure without creative efforts and all such embodiments fall within the scope of the present disclosure.

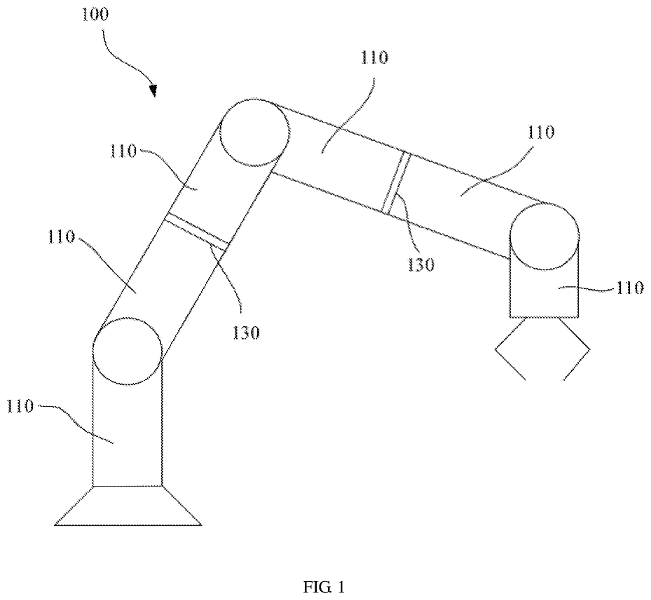

FIG. 1 illustrates an exemplary articulated robot 100 applied to an embodiment of the present disclosure, which is hereinafter referred to as a robot. The robot 100 may be an industrial robot or any other type of robot, for example, a humanoid type robot. The robot 100 may include a plurality of links 110 (also known as arms), light-emitting devices 130, and actuators (not shown). It should be appreciated that, in the exemplary robot shown in FIG. 1, the actuators are located within the links 110 and the light-emitting devices 130, and thus the actuators are not visible. The links 110 may rotate along a single axis (that is, one dimension), along two axes (that is, two dimensions), or may have freedom to move anywhere in a three-dimensional space.

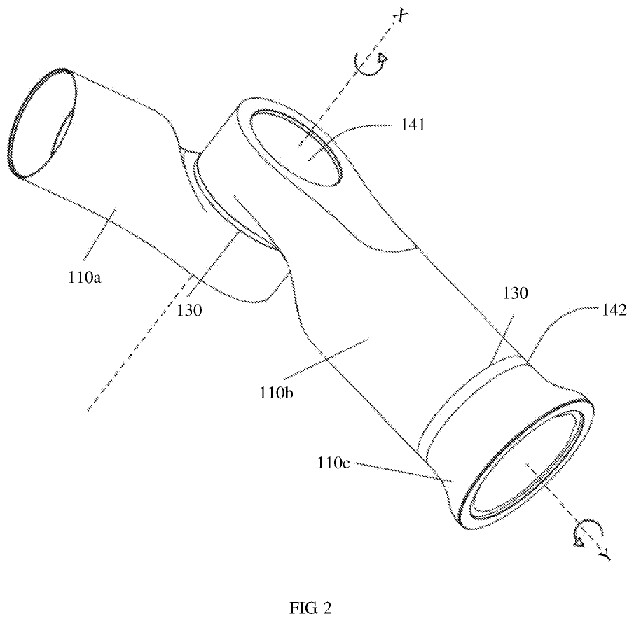

Two adjacent links 110 may form a pitch joint or a roll joint. Refer to FIG. 2 which illustrates part of the articulated robot. In FIG. 2, a link 110a and a link 110b may cooperatively form a pitch joint 141 that rotates around its respective illustrated axis A, while the link 110b and a link 110c may cooperatively form a roll joint 142 that rotates around its respective illustrated axis B. In either case, the light-emitting device 130 may be located between two links 110 (e.g., between the link 110a and the link 110b, or between the link 110b and the link 110c) adjacent to the actuator. It should be appreciated that two adjacent links 110 may form other types of rotary joints.

The light-emitting device 130 may be any type of device capable of generating visible light, such as an LED or a multi-color LED. The light-emitting device 130 is arranged at the rotary joint, for example, the pitch joint 141 or the roll joint 142. In some embodiments, one light-emitting device 130 is arranged at each rotary joint. In some embodiments, each light-emitting device 130 may correspond to one actuator, and may be arranged around the corresponding actuator. For example, the light-emitting device 130 may have a ring-configuration which extends around the whole circumference of the corresponding actuator. In such embodiments, an operator of the robot 100 may observe the light-emitting devices 130 at any position relative to the robot 100. Such a light-emitting device 130 located at the rotary joint and around the rotary joint will be hereinafter referred to as a joint ring lamp.

In addition, it should be appreciated that, in some embodiments, the light-emitting devices 130 may not extend along the entire circumference of the corresponding actuator. It should also be appreciated that the light-emitting devices 130 may be in any shape, such as a circle, an octagon, a decagon, or a wave. The light-emitting devices 130 are exposed at an exterior surface of the robot 100, so that the operator of the robot 100 may easily observe the illumination of the light-emitting devices 130.

As described above, in some embodiments, the light-emitting device 130 may be located between two adjacent links 110. For example, when two adjacent links 110 are connected together through an actuator, a gap (not shown) may exist between the two links 110, and the light-emitting device 130 may be located in the gap. In other embodiments, the light-emitting device 130 may be located near the corresponding actuator, but not in the above-described gap. For example, the light-emitting device 130 corresponding to the actuator may be located at an outer surface of either of the two adjacent links 110 connected through the actuator.

The light-emitting device 130 can display various colors, and is configured to display a corresponding color according to a received color instruction.

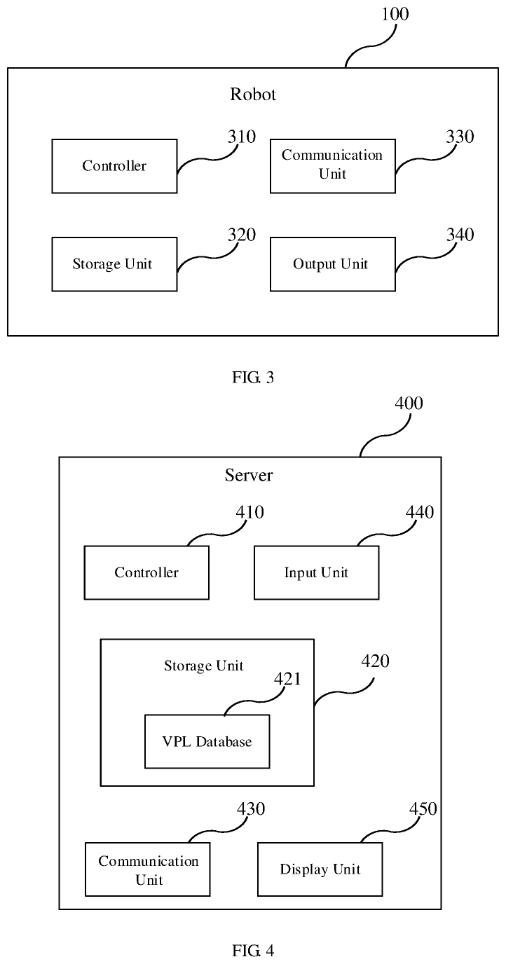

FIG. 3 illustrates a block diagram of a control system for the articulated robot 100 applied to an embodiment of the present disclosure. The control system has a controller 310, a storage unit 320, a communication unit 330, and an output unit 340. The control system may be configured to control a color displayed by the light-emitting device 130.

The controller 310 includes one or more processors. Each processor may be a general purpose processor or a specialized processor dedicated to specific processing, but is not limited thereto. The storage unit 320 includes one or more memories. Each memory may be a semiconductor memory, a magnetic surface memory, or an optical memory, but is not limited thereto. The storage unit 320 stores any information for operation of the robot 100.

The communication unit 330 has one or more communication modules. The communication module may communicate with an external device such as a server through wireless communication or wired communication. In some embodiments, the robot 100 may establish a communication connection with the external server through a cable via the communication unit 330. In other embodiments, the robot 100 may be connected to a network of the server via the communication unit 330. The robot 100 exchanges data with the server by using the communication unit 330.

The output unit 340 has one or more signal interfaces. Each signal interface is connected to the light-emitting device 130 through a signal transmission line. The output unit 340 is configured to transmit a color instruction generated by the controller 310 to the light-emitting device 130.

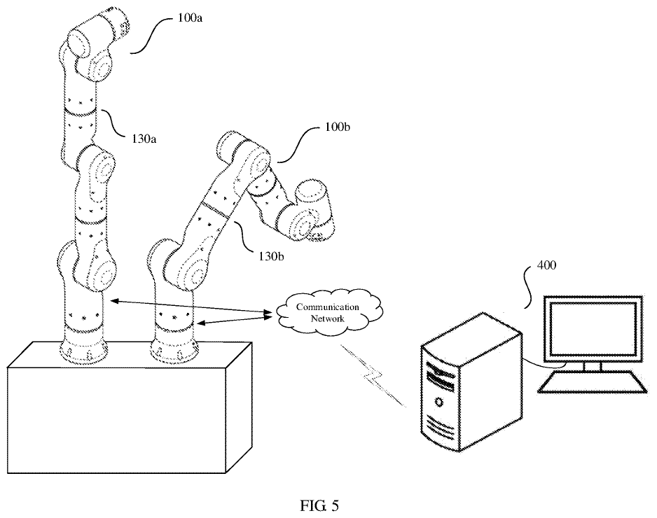

FIG. 4 illustrates a structure of a server 400 applied to an embodiment of the present disclosure. The server 400 has a controller 410, a storage unit 420, a communication unit 430, an input unit and a display unit 450. The server 400 may be a computer or formed by more than two computers that can communicate with each other.

The controller 410 includes one or more processors. Each processor may be a general-purpose processor or a specialized processor dedicated to specific processing, but is not limited thereto. The controller 410 controls operation of the server 400 according to control and processing programs stored in the storage unit 420.

The storage unit 420 includes one or more memories. Each memory may be a semiconductor memory, a magnetic surface memory, or an optical memory, but is not limited thereto. Each memory may be used as a main storage device, an auxiliary storage device, or a caching storage device of the server 400. The storage unit 420 stores a plurality of instructions executable by the controller 410, particularly stores programs for operation, control, and processing of the server 400, and stores various databases and any other information. More particularly, the storage unit 420 stores an IDE run by the server 400 and a VPL library that includes VPL blocks created and edited by the IDE.

The communication unit 430 has one or more communication modules. The communication module may communicate with a terminal device such as an articulated robot through wireless communication or wired communication. In some embodiments, the server 400 may establish a communication connection with the terminal device through a cable via the communication unit 430. In other embodiments, the server 400 may be connected to a network of the terminal device via the communication unit 430. The server 400 exchanges data with the terminal device by using the communication unit 430.

The input unit 440 is configured to receiver user input. The input unit 440 may include various combinations of devices that allow receiving user input such as a mouse, a keyboard, a remote control, and a joystick. In addition, the input unit 440 may include a touch screen data converter that can sense touch and interact with a display unit 450 and is overlaid on the display unit 450.

The display unit 450 may be any electronic video display such as an LCD display, an LED display, or of a similar display type. In some embodiments, the display unit 450 may be a touch screen, for example, a capacitive touch screen, a resistive touch screen, a surface acoustic wave touch screen, or the like. The touch screen may provide a user with an input interface and an output interface at the same time. In this case, the input unit 440 and the display unit 450 are integrated together. The display unit 450 may render a GUI, particularly a GUI of an IDE. The GUI has a variety of user selectable icons, menus, check boxes, dialogs, and graphic boxes, and other components and elements that can be selected by the user, so as to set an operation state or condition of the robot 100.

FIG. 5 illustrates a schematic diagram of a robot system according to an embodiment of the present disclosure. Two robots are arranged on a workbench, namely, a first robot 100a and a second robot 100b. The first robot 100a has a plurality of first joint ring lamps 130a, and the second robot 100b has a plurality of second joint ring lamps 130b. The first joint ring lamps 130a and the second joint ring lamps 130b are the light-emitting devices 130 described above. Details are not described herein again. Only one first joint ring lamp 130a and one second joint ring lamp 130b are marked respectively in the first robot 100a and the second robot 100b shown in FIG. 5. It should be appreciated that other first joint ring lamps 130a and second joint ring lamps 130b not marked exist in the first robot 100a and the second robot 100b shown in FIG. 5 respectively.

In this embodiment, only an example of a workstation with two robots is shown. It should be appreciated that the workstation may have only one robot or more than two robots. As described above, each robot can exchange data with the server 400 through wired connection or wireless connection. The server 400 sets an operation state or condition for each robot to control operation of the robot. In the embodiment shown in FIG. 5, the first robot 100a, the second robot 100b, and the server 400 are all connected to a communication network based on a communication protocol such as TCP/IP. Moreover, the first robot 100a, the second robot 100b, and the server 400 constitute a distributed data system using a data distributed service (DDS).

In a case where a plurality of robots exists on the workbench, in order to easily distinguish the robots from each other, there is a need to set visible and unique identifiers for the robots. In particular, in a process of programming the robots, it is extremely advantageous to visually identify a robot being programmed from the robots. Conventionally, the robots are in need of additional accessories, such as printed signs, digital displays, indicator lamps or other elements that display unique identification information of the robots. This increases the workload and leads to higher costs. In this embodiment, the robots can be identified more effectively and more intuitively by controlling the light-emitting devices of the robots to display different colors. For example, the first joint ring lamps 130a of the first robot 100a may be controlled to display blue, and the second joint ring lamps 130b of the second robot 100b may be controlled to display green. In this way, the two robots can be distinguished from each other just by identifying the colors displayed by the joint ring lamps. The process of controlling the colors of the joint ring lamps of the robots will be described in detail below.

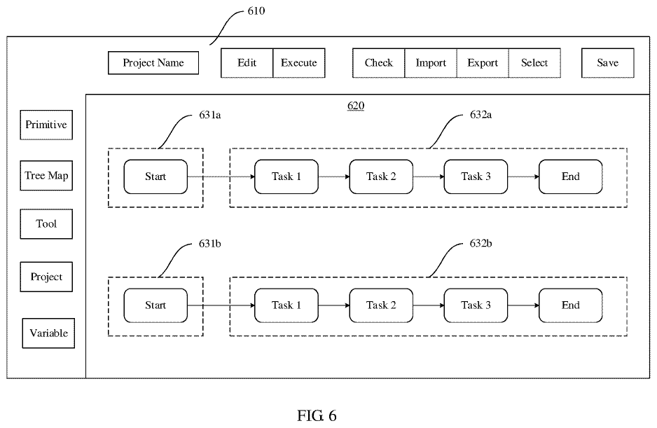

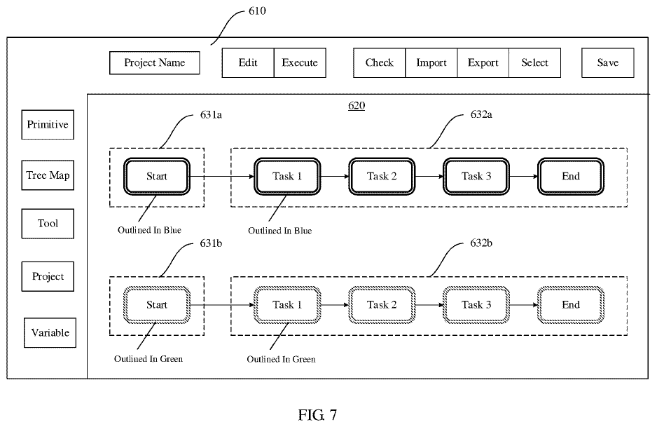

Refer to FIG. 6 together with FIG. 5. The first robot 100a, the second robot 100b, and the server 400 are all connected to a communication network. To enable the first robot 100a and the second robot 100b to perform respective expected operations, the user runs the IDE on the server 400 to program the first robot 100a and the second robot 100b. The controller 410 of the server 400 executes the instructions from the storage unit 420 to run the IDE. The GUI of the IDE is displayed on the display unit 450 of the server 400. The GUI provides the user with a VPL tool. The user may use the VPL tool to program the first robot 100a and the second robot 100b.

FIG. 6 illustrates a schematic diagram of creating a sequence of tasks of a robot by using a VPL tool according to an embodiment of the present disclosure. As shown in FIG. 6, a VPL tool 610 includes interactive elements such as buttons displayed in the GUI of the IDE and allowing the user to operate to create a sequence of tasks to be performed by the robot. The user operates the VPL tool 610 through the input unit 440 of the server 400 to create sequences of tasks for the first robot 100a and the second robot 100b in a task region 620 respectively. In FIG. 6, the sequence of tasks of the first robot 100a is formed by a first initial VPL block 631a and a plurality of first VPL task blocks 632a, and the sequence of tasks of the second robot 100b is formed by a second initial VPL block 631b and a plurality of second VPL task blocks 632b.

Creating a sequences of tasks of a robot may include: selecting an initial VPL block corresponding to the robot from a VPL library, that is, a block shown as “Start” in FIG. 6, and placing the initial VPL block in the task region 620; selecting task blocks corresponding to the robot from the VPL library, that is, blocks shown as “Task 1”, “Task 2”, “Task 3”, and “End” in FIG. 6; and connect the blocks by lines representing an order of execution, for example, lines with arrows, to form a series of tasks executed sequentially. Each task may include actions such as movement and rotation realized by any one or more of the plurality of links and the plurality of rotary joints of the robot, for example, movement by a certain distance, rotation by a certain angle, rotation in a certain direction, and so on. The VPL blocks may be converted into motion commands for the robot.

It should be appreciated that, for ease of description, the GUI of the IDE in FIG. 6 is simplified, and the creation of the sequence of tasks of the robot is also simplified. During specific implementation, the GUI may have richer interactive elements, and the creation of the sequence of tasks may be more complex. The IDE compiles and packages the sequence of tasks formed by the VPL blocks into a program executable by the robot, and then transmits the program to the robot. The robot executes the program to realize the expected operation.

In this embodiment, the user uses the VPL tool 610 to select the first initial VPL block 631a corresponding to the first robot 100a from the VPL library, and selects the second initial VPL block 631b corresponding to the second robot 100b from the VPL library. When the VPL library includes no initial VPL block corresponding to the robot, the user is required to create an initial VPL block and add the initial VPL block to the VPL library. The user may create the initial VPL block based on a unique identifier of the user by using the VPL tool in the IDE. The unique identifier includes an Internet protocol address of the robot, a serial number of the robot, or other information that uniquely identifies the robot. The server can identify a robot to be programmed by acquiring the unique identifier from the initial VPL block.

The initial VPL block for a robot is selected from the VPL library, and the initial VPL block is placed in the task region 620, which indicates that programming of the robot will begin. In this case, the IDE learns that the robot to be programmed has been added, and the server 400 may establish an IDE-based connection with the robot over the communication network. Alternatively, the server may establish an IDE-based connection with the robot while compiling or debugging the VPL blocks by using the IDE. The IDE-based connection means that the IDE running on the server can receive data from the robot and send the data generated by the IDE to the robot. The IDE-based connection may be a communication connection using a DDS protocol on top of a TCP/IP.

In this embodiment, the server 400 establishes a first connection based on the IDE with the first robot 100a over the communication network after selecting the first initial VPL block 631a, and the server 400 establishes a second connection based on the IDE with the second robot 100b over the communication network after selecting the second initial VPL block 631b.

As described above, in a case where a plurality of robots exists on the workbench, in order to distinguish the robots from each other, there is a need to add additional accessories that can be easily distinguished for the robots in the conventional art. This may lead to higher costs and increase the workload. In addition, in the conventional art, it is not easy to identify a robot being programmed on the workbench in the GUI. For example, a visible literal description about the VPL block may be in need to indicate which robot is being programmed. For example, referring to FIG. 5, a text description of “The robot on the left when viewed from the front of the workbench” might be added for the VPL block corresponding to the first robot 100a, and a text description of “The robot on the right when viewed from the front of the workbench” might be added for the VPL block corresponding to the second robot 100b. The text descriptions are not intuitive and affect legibility of VPL blocks.

Therefore, it is proposed in the present disclosure to assign different colors to different robots during the programming of a plurality of robots. For example, blue is assigned to the first robot 100a so that the first joint ring lamps 130a of the first robot 100a are controlled to display blue, while green is assigned to the second robot 100b so that the second joint ring lamps 130b of the second robot 100b are controlled to display green.

In order to achieve the above purpose, in this embodiment, in the process of using the VPL tool 610 to create an initial VPL block, the initial VPL block is created in association with the color assigned to the robot. For example, the first initial VPL block 631a is created in association with the first color information indicating the first color (i.e., blue) assigned to the first robot 100a, and the second initial VPL block 631b is created in association with the second color information indicating the second color (i.e., blue) assigned to the second robot 100b. In this way, the color information indicating the assigned color is saved in the initial VPL block.

Optionally, the user may modify the color information to indicate a different color by editing the initial VPL block stored in the VPL library. For example, the user may use the VPL tool to edit the first initial VPL block 631a to modify the first color information contained in the first initial VPL block 631a, so that modified first color information indicates a color different from the first color, for example, purple. Similarly, the user may also edit the second initial VPL block 631b so that modified second color information indicates a color different from the second color.

In this embodiment, the server 400 may acquire first color information indicating a first color from the first initial VPL block 631a, acquire second color information indicating a second color from the second initial VPL block 631b, and send the acquired first color information and the acquired second color information to the first robot 100a and the second robot 100b respectively via the first connection and the second connection.

The controller 310 of the first robot 100a may generate a first color instruction in response to the received first color information to control the first joint ring lamps 130a of the first robot 100a to display the first color, i.e., blue. The controller 310 of the second robot 100b may generate a second color instruction in response to the received second color information to control the second joint ring lamps 130b of the second robot 100b to display the second color, i.e., green. In this way, the first robot 100a and the second robot 100b can be easily and intuitively distinguished by identifying the color of the first joint ring lamps 130a of the first robot 100a and the second joint ring lamps 130b of the second robot 100b.

It should be appreciated that, in a case where the first robot 100a and the second robot 100b are connected to a communication network of the server 400, the first robot 100a or the second robot 100b may not establish an IDE-based connection with the server 400 if the VPL library includes no initial VPL block of the first robot 100a or the second robot 100b or the user does not select the initial VPL block of the first robot 100a or the second robot 100b. The first robot 100a or the second robot 100b may not receive color information from the server 400 when the first robot 100a or the second robot 100b does not establish the IDE-based connection with the server 400. In this case, the first robot 100a or the second robot 100b may control the first joint ring lamps 130a or the second joint ring lamps 130b to display a preset color. The preset color is stored in the storage unit 320 of the first robot 100a or the second robot 100b. Alternatively, the first robot 100a or the second robot 100b may control the first joint ring lamps 130a or the second joint ring lamps 130b to display a color indicated by color information previously received by the first robot 100a or the second robot 100b. The color information previously received means color information received from the server the last time the robot established an IDE-based connection with a server. The server may be the server 400 or another server.

In this embodiment, a robot system with two robots is discussed. A robot system with three robots will be briefly introduced below. Those of ordinary skill in the art may envisage a robot system with more than three robots based on this, which will not be repeated herein.

The user may assign a third color (e.g., purple) different from the first color and the second color to a third robot. For the third robot, the user uses the VPL tool to create a third initial VPL block in association with third color information indicating a third color based on a unique identifier of the third robot, and stores the third initial VPL block in the VPL library.

When there is a need to program the third robot in the robot system, the user uses the VPL tool to select the third initial VPL block corresponding to the third robot from the VPL library. The server establishes a third connection based on the IDE with the third robot over the communication network after selecting the third initial VPL block. The server acquires the third color information indicating the third color from the third initial VPL block, and sends the acquired third color information to the third robot via the established third connection. A robot controller of the third robot generates a third color instruction in response to the received third color information to control joint ring lamps of the third robot to display the third color.

Still referring to FIG. 6, the user may select the plurality of first task VPL blocks 632a corresponding to the first robot 100a from the VPL library to constitute a sequence of tasks to be performed by the first robot 100a together with the first initial VPL block 631a. Moreover, the user may select the plurality of second task VPL blocks 632b corresponding to the second robot 100b from the VPL library to constitute a sequence of tasks to be performed by the second robot 100b together with the second initial VPL block 631b. The task VPL blocks may be created similarly to the initial VPL blocks and stored in the VPL library.

In an embodiment of the present disclosure, to easily distinguish a plurality of robots being programmed on the GUI, the VPL blocks corresponding to the robots are displayed in association with the colors assigned to the robots. For example, for the first robot 100a, each of the first initial VPL block 631a and the plurality of first task VPL blocks 632a is displayed in association with the first color, while for the second robot 100b, each of the second initial VPL block 631b and the plurality of second task VPL blocks 632b is displayed in association with the second color. For example, at least part of each of the first initial VPL block 631a and the plurality of first task VPL blocks 632a presents the first color, while at least part of each of the second initial VPL block 631b and the plurality of second task VPL blocks 632b presents the second color.

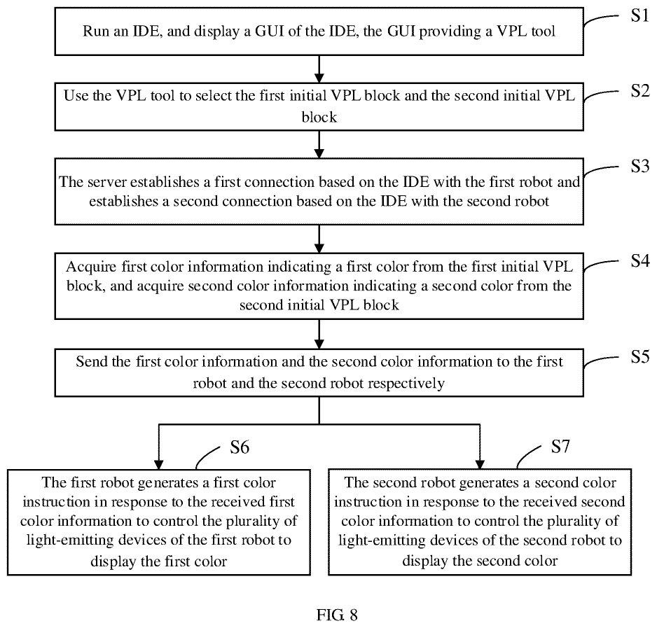

FIG. 7 illustrates one manner of displaying VPL blocks in association with colors. In the embodiment shown in FIG. 7, the first initial VPL block 631a and the first task VPL blocks 632a are outlined in blue (e.g., the first color), and the second initial VPL block 631b and the second task VPL blocks 632b are outlined in green (i.e., the second color). In FIG. 7, to show that the VPL block is outlined in “blue” or “green”, “outlined in blue” and “outlined in green” are specially marked with text. It should be appreciated that this is only for ease of illustration. In practice, such text annotation does not exist. Since the first initial VPL block 631a and the first task VPL blocks 632a are outlined in blue, contours of the first initial VPL block 631a and the first task VPL blocks 632a are in blue. Moreover, since the second initial VPL block 631b and the second task VPL blocks 632b are outlined in green, contours of the second initial VPL block 631b and the second task VPL blocks 632b are in green. In this way, through the identification of blue or green, which group of VPL blocks corresponds to the first robot 100a and which group of VPL blocks corresponds to the second robot 100b can be distinguished. For example, when the sequence of tasks of the first robot 100a displaying blue (i.e., the first joint ring lamps 130a display blue) is required to be modified, the user can quickly find a group of VPL blocks outlined in blue from the task region 620 of the displayed GUI and edit at least one VPL block in the group, or add or delete at least one VPL block to or from the group.

It should be appreciated that the VPL blocks may be displayed in association with the colors in other manners. For example, the first color is rendered by part or all of an underlying color of each VPL block corresponding to the first robot 100a, and the second color is rendered by part or all of an underlying color of each VPL block corresponding to the second robot 100b.

Alternatively, the first color may be marked in text form in each initial VPL block corresponding to the first robot 100a, and the second color may be marked in text form in each VPL block corresponding to the second robot 100b.

The above embodiment describes the robot system according to the present disclosure. In the robot system according to the present disclosure, the user can identify the robots more effectively and more intuitively by controlling the light-emitting devices of the robots to display different colors. In addition, the user can easily identify the VPL blocks corresponding to the robots by displaying a group of VPL blocks corresponding to the robots in association with the colors assigned to the robots in the GUI.

A color control method applied to a robot system according to the present disclosure will be described below.

FIG. 8 illustrates a flowchart of a color control method for use in the robot system shown in FIG. 5. It would be understood by those of ordinary skill in the art that the method is also applicable to any other suitable robot systems. An exemplary robot system includes a server and at least two articulated robots. Each of the articulated robots includes a robot controller, a plurality of rotary joints, and a plurality of light-emitting devices. Each of the light-emitting devices is arranged at the corresponding rotary joint of the plurality of rotary joints. The at least two articulated robots and the server are connected to a communication network.

Referring to FIG. 5, in this embodiment, the robot system includes a first robot 100a, a second robot 100b, and a server 400. The first robot 100a has a plurality of first joint ring lamps 130a, and the second robot 100b has a plurality of second joint ring lamps 130b. The first robot 100a, the second robot 100b, and the server 400 are all connected to a communication network based on a communication protocol such as a TCP/IP. Moreover, the first robot 100a, the second robot 100b, and the server 400 constitute a distributed data system using a DDS. Configurations for the robot and the server may be obtained with reference to the above descriptions. Details are not described herein again.

In step S1, the server 400 runs an IDE, and displays a GUI of the IDE on the display unit 450. The GUI provides the user with a VPL tool. The user may use the VPL tool to program the first robot 100a and the second robot 100b. Referring to FIG. 6, the VPL tool 610 includes interactive elements such as buttons displayed in the GUI of the IDE and allowing the user to operate to create a sequence of tasks to be performed by the robot. The user operates the VPL tool 610 through the input unit 440 of the server 400 to create sequences of tasks for the first robot 100a and the second robot 100b in a task region 620 respectively.

In step S2, the user uses the VPL tool 610 to select the first initial VPL block 631a corresponding to the first robot 100a from the VPL library, and selects the first initial VPL block 631b corresponding to the first robot 100b from the VPL library. The first initial VPL block 631a has first color information indicating a first color (e.g., blue). The second initial VPL block 631b has second color information indicating a second color (e.g., green).

In step S3, the server 400 establishes a first connection based on the IDE with the first robot 100a over the communication network after selecting the first initial VPL block 631a, and the server 400 establishes a second connection based on the IDE with the second robot 100b over the communication network after selecting the second initial VPL block 631b. The IDE-based connection means that the IDE running on the server can receive data from the robot and send the data generated by the IDE to the robot. The IDE-based connection may be a communication connection using a DDS protocol on a top layer of TCP/IP.

In step S4, the server 400 may acquire first color information indicating a first color from the first initial VPL block 631a, and acquire second color information indicating a second color from the second initial VPL block 631b.

In step S5, the server 400 sends the acquired first color information and the acquired second color information to the first robot 100a and the second robot 100b respectively via the first connection and the second connection.

In step S6, the controller 310 of the first robot 100a generates a first color instruction in response to the received first color information to control the first joint ring lamps 130a of the first robot 100a to display the first color, i.e., blue.

In step S7, the controller 310 of the second robot 100b generates a second color instruction in response to the received second color information to control the second joint ring lamps 130b of the second robot 100b to display the second color, i.e., green.

In this embodiment, each robot has a unique identifier. The unique identifier includes an Internet protocol address of the robot, a serial number of the robot, or other information that uniquely identifies the robot. The color control method further includes: using, through the server 400, the VPL tool 610 to create the first initial VPL block 631a in association with the first color information based on the unique identifier of the first robot 100a and create the second initial VPL block 631b in association with the second color information based on the unique identifier of the second robot 100b, and adding the created first initial VPL block 631a and the created second initial VPL block 631b to the VPL library stored in the storage unit 420 of the server 400.

The color control method further includes: using, through the server 400, the VPL tool 610 to edit the initial VPL block stored in the VPL library to modify the color information, so as to indicate a different color. For example, the user may use the VPL tool to edit the first initial VPL block 631a to modify the first color information included in the first initial VPL block 631a, so that modified first color information indicates a color different from the first color, for example, purple. Similarly, the user may also edit the second initial VPL block 631b so that modified second color information indicates a color different from the second color.

In a case where the first robot 100a and the second robot 100b are connected to a communication network of the server 400, the first robot 100a or the second robot 100b may not establish an IDE-based connection with the server 400 if the VPL library includes no initial VPL block of the first robot 100a or the second robot 100b or the user does not select the initial VPL block of the first robot 100a or the second robot 100b. The first robot 100a or the second robot 100b may not receive color information from the server 400 when the first robot 100a or the second robot 100b does not establish the IDE-based connection with the server 400. In this case, the color control method further includes: controlling, by the first robot 100a or the second robot 100b, the first joint ring lamps 130a or the second joint ring lamps 130b to display a preset color. The preset color is stored in the storage unit 320 of the first robot 100a or the second robot 100b. Alternatively, the color control method further includes: controlling, by the first robot 100a or the second robot 100b, the first joint ring lamps 130a or the second joint ring lamps 130b to display a color indicated by color information previously received by the first robot 100a or the second robot 100b. The color information previously received means color information received from the server the last time the robot established an IDE-based connection with a server. The server may be the server 400 or another server.

In other embodiments, the robot system may include more than three robots. A robot system with three robots will be briefly introduced below. Those of ordinary skill in the art may envisage a robot system with more than three robots based on this. The user may assign a third color (e.g., purple) different from the first color and the second color to a third robot. For the third robot, the user uses the VPL tool to create a third initial VPL block in association with third color information indicating a third color based on a unique identifier of the third robot, and stores the third initial VPL block in the VPL library.

The color control method further includes: using, through the server 400, the VPL tool 610 to select the third initial VPL block corresponding to the third robot from the VPL library; establishing, by the server 400, a third connection based on the IDE with the third robot over the communication network in response to the selection of the third initial VPL block; acquiring, by the server, the third color information indicating the third color from the third initial VPL block, and sending the acquired third color information to the third robot via the established third connection; and generating, by a robot controller of the third robot, a third color instruction in response to the received third color information to control joint ring lamps of the third robot to display a third color.

Refer to the schematic diagram of creating a sequence of tasks of a robot by using a VPL tool shown in FIG. 6. To easily distinguish a plurality of robots being programmed in the GUI, the VPL blocks corresponding to the robots are displayed in association with the colors assigned to the robots. The color control method further includes: displaying the first initial VPL block 631a and the plurality of first task VPL blocks 632a corresponding to the first robot 100a in association with the first color; and displaying the second initial VPL block 631b and the plurality of second task VPL blocks 632b corresponding to the second robot 100b in association with the second color. For example, at least part of each of the first initial VPL block 631a and the plurality of first task VPL blocks 632a is colored by the first color, while at least part of each of the second initial VPL block 631b and the plurality of second task VPL blocks 632b is colored by the second color.

As shown in FIG. 7, in an embodiment, the first initial VPL block 631a and the first task VPL blocks 632a are outlined in blue (e.g., the first color), and the second initial VPL block 631b and the second task VPL blocks 632b are outlined in green (i.e., the second color). Since the first initial VPL block 631a and the first task VPL blocks 632a are outlined in blue, contours of the first initial VPL block 631a and the first task VPL blocks 632a are in blue. Moreover, since the second initial VPL block 631b and the second task VPL blocks 632b are outlined in green, contours of the second initial VPL block 631b and the second task VPL blocks 632b are in green. In this way, through the identification of blue or green, which group of VPL blocks corresponds to the first robot 100a and which group of VPL blocks corresponds to the second robot 100b can be distinguished.

As described above, the VPL blocks may be displayed in association with the colors in other manners. For example, the first color is rendered by part or all of an underlying color of each VPL block corresponding to the first robot 100a, and the second color is rendered by part or all of an underlying color of each VPL block corresponding to the second robot 100b. Alternatively, the first color may be marked in text form in each initial VPL block corresponding to the first robot 100a, and the second color may be marked in text form in each VPL block corresponding to the second robot 100b.

Those of ordinary skill in the art should appreciate that each of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the instructions, performs or facilitates the performance of all or part of the disclosed methods and procedures.

Those of ordinary skill in the art should appreciate that, to make the descriptions brief, the foregoing method embodiments are expressed as a series of actions. However, the present disclosure is not limited to the described action sequence, because according to the present disclosure, some steps may be performed in other sequences or performed simultaneously. In addition, those of ordinary skill in the art should also appreciate that all the embodiments described in the specification are optional embodiments, and the actions involved are not necessarily mandatory to the present disclosure.

The above embodiments only describe several implementations of the present disclosure, which are described specifically and in detail, but cannot be therefore construed as a limitation on the patent scope of the present disclosure. It should be pointed out that those of ordinary skill in the art may also make several transformations and improvements without departing from the ideas of the present disclosure, all of which fall within the protection scope of the present disclosure. Therefore, the patent protection scope of the present disclosure shall be subject to the appended claims.

1. A robot system, comprising at least two articulated robots and a server, wherein
each of the at least two articulated robots comprises a robot controller, a plurality of rotary joints, and a plurality of light-emitting devices, each of the light-emitting devices being arranged at the corresponding rotary joint of the plurality of rotary joints; and
the sever comprises a controller, a storage unit, and a display unit, the storage unit storing a plurality of instructions executable by the controller and storing a visual programming language (VPL) library comprising a plurality of VPL blocks;
wherein:
the at least two articulated robots and the server are connected to a communication network;
the at least two articulated robots comprise a first articulated robot and a second articulated robot;
the server is configured to use the controller to execute the instructions from the storage unit to run an integrated development environment (IDE), and use the display unit to display a graphical user interface (GUI) of the IDE, the GUI being configured to provide a VPL tool;
the server is configured to use the VPL tool to select a first initial VPL block and a second initial VPL block from the VPL library, the first initial VPL block corresponding to the first articulated robot, the second initial VPL block corresponding to the second articulated robot, the server establishing a first connection based on the IDE with the first articulated robot over the communication network after selecting the first initial VPL block, and the server establishing a second connection based on the IDE with the second articulated robot over the communication network after selecting the second initial VPL block;
the server is configured to acquire first color information indicating a first color from the first initial VPL block, and acquire second color information indicating a second color from the second initial VPL block, the second color being different from the first color;
the server is configured to send the acquired first color information and the acquired second color information to the first articulated robot and the second articulated robot respectively via the first connection and the second connection;
the robot controller of the first articulated robot is configured to generate a first color instruction in response to the received first color information to control the plurality of light-emitting devices of the first articulated robot to display the first color; and
the robot controller of the second articulated robot is configured to generate a second color instruction in response to the received second color information to control the plurality of light-emitting devices of the second articulated robot to display the second color.

2. The robot system according to claim 1, wherein each of the at least two articulated robots has a unique identifier, the server is configured to use the VPL tool to create the first initial VPL block in association with the first color information based on the unique identifier of the first articulated robot and create the second initial VPL block in association with the second color information based on the unique identifier of the second articulated robot, and the server is further configured to add the created first initial VPL block and the created second initial VPL block to the VPL library stored in the storage unit.

3. The robot system according to claim 2, wherein the unique identifier of each of the at least two articulated robots is selected from an Internet protocol address of the articulated robot or a serial number of the articulated robot.

4. The robot system according to claim 1, wherein the server is configured to use the VPL tool to edit the first initial VPL block or the second initial VPL block to modify the first color information or the second color information contained in the first initial VPL block or the second initial VPL block, the modified first color information or second color information indicating a color different from the first color or the second color.

5. The robot system according to claim 1, wherein the robot controller of each articulated robot is configured to control the plurality of light-emitting devices of the articulated robot to display a preset color when the articulated robot does not establish a connection based on the IDE with the server.

6. The robot system according to claim 1, wherein the robot controller of each articulated robot is configured to control the plurality of light-emitting devices of the articulated robot to display a color indicated by color information previously received by the articulated robot when the articulated robot does not establish a connection based on the IDE with the server.

7. The robot system according to claim 1,
wherein the server is configured to:
use the VPL tool to select a plurality of first task VPL blocks and a plurality of second task VPL blocks from the VPL library, the plurality of first task VPL blocks corresponding to the first articulated robot, the plurality of second task VPL blocks corresponding to the second articulated robot; and
display each of the first initial VPL block and the plurality of first task VPL blocks in association with the first color, and display each of the second initial VPL block and the plurality of second task VPL blocks in association with the second color; and
wherein the first initial VPL block and the plurality of first task VPL blocks constitute a sequence of tasks to be performed by the first articulated robot, and the second initial VPL block and the plurality of second task VPL blocks constitute a sequence of tasks to be performed by the second articulated robot.

8. The robot system according to claim 7, wherein at least part of each of the first initial VPL block and the plurality of first task VPL blocks presents the first color, and at least part of each of the second initial VPL block and the plurality of second task VPL blocks presents the second color.

9. The robot system according to claim 8, wherein each of the first initial VPL block and the plurality of first task VPL blocks is outlined in the first color, and each of the second initial VPL block and the plurality of second task VPL blocks is outlined in the second color.

10. The robot system according to claim 7, wherein the first color is marked in text form in each of the first initial VPL block and the plurality of first task VPL blocks, and the second color is marked in text form in each of the second initial VPL block and the plurality of second task VPL blocks.

11. A color control method for a robot system, the robot system comprising a server and at least two articulated robots, each of the articulated robots having a robot controller, a plurality of rotary joints, and a plurality of light-emitting devices, each of the light-emitting devices being arranged at the corresponding rotary joint of the plurality of rotary joints, the at least two articulated robots and the server being connected to a communication network, the at least two articulated robots comprising a first articulated robot and a second articulated robot, the server comprising a storage unit, the storage unit storing a visual programming language (VPL) library comprising a plurality of VPL blocks; the color control method comprising:
running, through the server, an integrated development environment (IDE), and displaying a graphical user interface (GUI) of the IDE, the GUI being configured to provide a VPL tool;
using, through the server, the VPL tool to select a first initial VPL block and a second initial VPL block from the VPL library, the first initial VPL block corresponding to the first articulated robot, the second initial VPL block corresponding to the second articulated robot;
in response to the selection of the first initial VPL block, the server establishing a first connection based on the IDE with the first articulated robot over the communication network, and in response to the selection of the second initial VPL block, the server establishing a second connection based on the IDE with the second articulated robot over the communication network;
acquiring, through the server, first color information indicating a first color from the first initial VPL block, and acquiring second color information indicating a second color from the second initial VPL block, wherein the second color is different from the first color;
sending, through the server, the acquired first color information and the acquired second color information to the first articulated robot and the second articulated robot respectively via the first connection and the second connection;
generating a first color instruction through the first articulated robot in response to the received first color information to control the plurality of light-emitting devices of the first articulated robot to display the first color; and
generating a second color instruction through the second articulated robot in response to the received second color information to control the plurality of light-emitting devices of the second articulated robot to display the second color.

12. The color control method according to claim 11, wherein each of the at least two articulated robots has a unique identifier, and the color control method further comprises:
using, through the server, the VPL tool to create the first initial VPL block in association with the first color information based on the unique identifier of the first articulated robot and create the second initial VPL block in association with the second color information based on the unique identifier of the second articulated robot, and adding the created first initial VPL block and the created second initial VPL block to the VPL library stored in the storage unit.

13. The color control method according to claim 12, wherein the unique identifier of each of the at least two articulated robots is selected from an Internet protocol address of the articulated robot or a serial number of the articulated robot.

14. The color control method according to claim 11, wherein the color control method further comprises:
using, through the server, the VPL tool to edit the first initial VPL block or the second initial VPL block to modify the first color information or the second color information contained in the first initial VPL block or the second initial VPL block, the modified first color information or second color information indicating a color different from the first color or the second color.

15. The color control method according to claim 11, wherein the color control method further comprises:
when any of the at least two articulated robots does not establish a connection based on the IDE with the server, controlling, through the articulated robot, the plurality of light-emitting devices of the articulated robot to display a preset color.

16. The color control method according to claim 11, wherein the color control method further comprises:
when any of the at least two articulated robots does not establish a connection based on the IDE with the server, controlling, through the articulated robot, the plurality of light-emitting devices of the articulated robot to display a color indicated by color information previously received by the articulated robot.

17. The color control method according to claim 10, wherein the color control method further comprises:
using, through the server, the VPL tool to select a plurality of first task VPL blocks and a plurality of second task VPL blocks from the VPL library, the plurality of first task VPL blocks corresponding to the first articulated robot, the plurality of second task VPL blocks corresponding to the second articulated robot; and
displaying each of the first initial VPL block and the plurality of first task VPL blocks in association with the first color, and displaying each of the second initial VPL block and the plurality of second task VPL blocks in association with the second color;
wherein the first initial VPL block and the plurality of first task VPL blocks constitute a sequence of tasks to be performed by the first articulated robot, and the second initial VPL block and the plurality of second task VPL blocks constitute a sequence of tasks to be performed by the second articulated robot.

18. The color control method according to claim 17, wherein at least part of each of the first initial VPL block and the plurality of first task VPL blocks is colored by the first color, and at least part of each of the second initial VPL block and the plurality of second task VPL blocks is colored by the second color.

19. The color control method according to claim 18, wherein each of the first initial VPL block and the plurality of first task VPL blocks is outlined in the first color, and each of the second initial VPL block and the plurality of second task VPL blocks are outlined in the second color.

20. The color control method according to claim 18, wherein the first color is marked in text form in each of the first initial VPL block and the plurality of first task VPL blocks, and the second color is marked in text form in each of the second initial VPL block and the plurality of second task VPL blocks.
